(19) United States
(12) Patent Application Publication
(10) Pub. No.: US 2026/0288511 A1
(43) Pub. Date: Sep. 24, 2026

(54) UNIKERNEL BASED EXECUTION OF SOFTWARE APPLICATIONS TO FACILITATE REGULATORY COMPLIANCE

(71) Applicant: Red Hat, Inc., Raleigh, NC (US)

(72) Inventors: Leigh Griffin, Waterford (IE); Luigi Mario Zuccarelli, Milan (IT)

(73) Assignee: Red Hat, Inc., Raleigh, NC (US)

(21) Appl. No.: 19/032,858

(22) Filed: Jan. 21, 2025

(51) Int. Cl. G06F 9/46; G06F 9/50

(52) U.S. Cl. CPC G06F 9/468; G06F 9/5055; G06F 2209/5022

(57) ABSTRACT

A system can be provided for deploying a software application in a unikernel to facilitate safety compliance. For example, the system may determine that a software application associated with a computing system satisfies encapsulation criteria of the computing system. The software application may further be associated with a functional safety standard issued by a standard-setting organization. The system may then identifying a minimum set of dependencies for executing the software application on the computing system. Additionally, the system can generate a unikernel comprising the software application and the minimum set of dependencies and deploy the unikernel on the computing system to facilitate execution of the software application on the computing system and compliance of the software application with the functional safety standard.

### TECHNICAL FIELD

The present disclosure relates generally to software application deployment. More specifically, but not by way of limitation, this disclosure relates to deploying a software application in a unikernel to facilitate regulatory compliance.

### BACKGROUND

Many organizations around the globe have developed regulatory standards (e.g., functional safety standards) for software and electronics. Functional safety relates to reducing risks so that computing systems function safely in the event that there is a malfunction. One example of a functional safety standard is ISO 26262 for automotive electronics. Functional safety standards can be used to avoid or mitigate systematic failures and hardware failures to prevent hazardous operational situations. An operating system can be certified to a functional safety standard based on a target level of risk reduction. For example, an Automotive Safety Integrity Level (ASIL) assignment with respect to ISO 26262 has four possible levels of safety requirements: ASIL A, ASIL B, ASIL C, and ASIL D. ASIL D has the highest safety requirements of the four possible levels and includes the safety requirements of the three preceding levels.

### BRIEF DESCRIPTION OF THE DRAWINGS

FIG. 1 is a block diagram of an example of a computing environment for deploying a software application in a unikernel to facilitate regulatory compliance according to some embodiments of the present disclosure.

FIG. 2 is a block diagram of an example of a computing system for deploying a software application in a unikernel to facilitate regulatory compliance according to some embodiments of the present disclosure.

FIG. 3 is a flowchart of a process for deploying a software application in a unikernel to facilitate regulatory compliance according to some embodiments of the present disclosure.

### DETAILED DESCRIPTION

A computing system may not be able to control external computing devices that are plugged in or otherwise associated with the computing system. As such, external software services executed in association with the computing system (e.g., executing on the external computing devices) may not be controlled by the computing system. There may be communication between the external services and software applications executing on the computing system (e.g., data can flow between the external services and the software applications). However, due to the lack of control, the computing system may lack control of what data is exposed during the communication. For example, data being sent by a software application to an external service may expose a functional endpoint, may expose information within logs that allow an attack vector to learn an endpoint, or may expose a public or private key of the computing system. Consequently, private data may be exposed to an external service that is not intended to have access to the privacy data, leading to security issues for the computing system. This lack of secure, controlled data flow and exposure may render the computing system incompliant with one or more regulatory standards (e.g., functional safety standards) issued by standard-setting organizations.

Some examples of the present disclosure can overcome one or more of the issues mentioned above by a system that can generate and deploy unikernels that each include a software application or software function and a minimum set of dependencies for running the software application or function on a computing system. More specifically, in some examples, each software application or software function of the computing system that communicates with an external service is assigned to and deployed within a unikernel. For example, the system may determine whether a software application has outbound capabilities (e.g., communicates with one or more external services). If the software application has outbound capabilities, the system can port the software application to a unikernel. In doing so, a base unikernel can be modified to encapsulate the software application's logic. The unikernel may further be modified such that the unikernel contains only the dependencies (e.g., libraries, device drivers, basic operating system components) needed for the software application to run. The resulting unikernel can be a lightweight binary image specialized for running the software application. Due to the resulting unikernel being lightweight (e.g., including the software application and dependencies for running the software application), an attack surface and security vulnerabilities associated with the software application can be minimized and deterministic behavior of the software application can be ensured. Furthermore, data communication between the unikernel running the software application and external services can be managed through a secure channel (e.g., a secure application program interface (API)). This can reduce a risk of data breaches or unauthorized access to the data, thereby enabling data to be transmitted, accessed, and used by the software application and external services in a controlled manner that is compliant with safety requirements.

Thus, the system can ensure compliance with regulatory standards (e.g., functional safety standards) by isolating each of one or more software applications, software functions, or a combination thereof of a computing system in a unikernel. The isolation can further reduce a risk of interference when running each software application, software function, or the combination thereof in a shared resource environment (e.g., the computing system). Additionally, because the unikernels are specialized for running the corresponding software applications or functions, the unikernels can each be designed to meet any specific safety requirements, computing resource requirements, or the like of the software application or function, thereby enhancing overall safety and performance of the computing system.

In one particular example, a vehicle may include a navigation application that communicates with one or more real-time traffic services. The system may determine that the navigation service meets encapsulation criteria based on detecting that the navigation application communicates with the real-time traffic services. The encapsulation criteria can be a set of criteria that, when satisfied by a software application, indicates to the system that the software should be encapsulated in a unikernel. Thus, in the particular example, the encapsulation criteria includes communication with external services (e.g., the real-time traffic services).

Subsequent to determining that the software application satisfies the encapsulation criteria, the system can identify a minimum set of dependencies for executing the navigation application on the vehicle. The system may do so based on a configuration file associated with the navigation application. The minimum set of dependencies may include system libraries, runtime libraries, device drivers, operating system components (e.g., a networking stack, memory management, etc.), or the like. The system can then bundle the navigation application (e.g., application code) and the minimum set of dependencies into a single executable binary, thereby generating a unikernel with the navigation application and the minimum set of dependencies. The system can then deploy the unikernel on the vehicle to facilitate execution of the software application on the vehicle. The unikernel may then communicate with the real-time traffic services through secure channels (e.g., secure APIs).

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

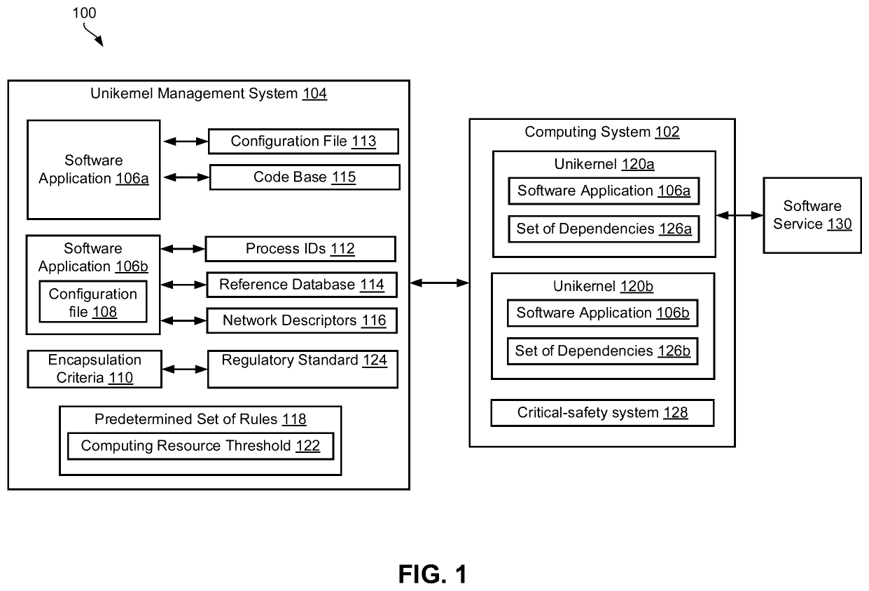

FIG. 1 is a block diagram of an example of a computing environment 100 for deploying a software application in a unikernel to facilitate safety compliance according to some embodiments of the present disclosure. The computing environment 100 can be a cloud computing environment, a distributed computing environment (e.g., an edge computing environment), or the like. The computing environment 100 can include an unikernel management system 104 and a computing system 102. The unikernel management system 104 may be part of the computing system 102 or the unikernel management system 104 may be external to and communicatively coupled with the computing system 102. For example, the unikernel management system 104 and the computing system 102 may be communicatively coupled via a network, such as a local area network (LAN), wide area network (WAN), the Internet, or any combination thereof. Examples of the computing system 102 can include an automotive system, medical device system, desktop computer, laptop computer, server, mobile phone, or tablet. The unikernel management system 104 can be or be associated with a workload lifecycle management system, a functional safety (FUSA) tooling system, or the like.

In some examples, one or more regulatory standards can be associated with the computing system 102 to avoid or mitigate systematic failures and hardware failures. For example, the computing system 102 can include a critical-safety system 128. The critical-safety system 128 can be a system that may cause hazardous operational situations (e.g., harm to a user of the computing system 102 or to an environment associated with the computing system 102) if the system fails or malfunctions. Alternatively, the critical-safety system 128 can be a system that stores, processes, or otherwise interacts with private data (e.g., medical records). In either case, software applications 106a-b executing on the computing system 102 can be required comply with one or more regulatory standards (e.g., a functional safety standard) for the critical-safety system 128.

A safety certification can provide confirmation that the software applications 106a-b comply with the one or more regulatory standards. The safety certification may be overseen by a standard-setting organization (e.g., International Organization for Standardization (ISO), International Electrotechnical Commission (IEC), etc.). Examples of the safety certification associated with transportation can include ISO 26262 for road vehicles, ISO 25119 for machinery associated with agriculture and forestry, and ISO 15998 for earth-moving machinery. Medical applications of the safety certification may include IEC 60601 for medical devices or IEC 62304 for medical device software. Additionally, compliance-related policies (e.g., the Health Insurance Portability and Accountability Act (HIPAA), etc.) may involve a similar certification with respect to safety. To receive or prevent invalidation of the safety certification for the software applications 106a-b, the unikernel management system 104 can generate and deploy unikernels 120a-b that include the software applications 106a-b and dependencies 126a-b of the software applications.

The unikernels 120a-b can each be a lightweight specialized binary designed to run the corresponding respective one of the software applications 106a-b. Due to the each of the unikernels 120a-b being light weight (e.g., only containing the respective one of the software applications 106a-b and corresponding dependencies 126a-b), specialized for running the software applications 106a-b, and excluding additional components of traditional operating systems (e.g., multi-user support, shells and command-line interfaces, dynamic libraries, etc.), an attack surface and security vulnerabilities associated with the software applications 106a-b can be minimized. Moreover, the unikernels 120a-b being lightweight and specifically designed for the software applications 106a-b can facilitate deterministic behavior of the software applications 106a-b. Furthermore, data communication between the unikernels 120a-b and software services external to the computing system 102 (e.g., software service 130) can be managed through a secure channel (e.g., a secure application program interface, a virtual private network, HTTPS, secure shell, or the like). In this way, a risk of data breaches or unauthorized access the data communication can be minimized. Minimizing the attack surface and security vulnerabilities, minimizing the risk of data breaches or unauthorized access the data communication, and facilitating the deterministic behavior may help to receive or prevent invalidation of the safety certification for the software applications 106a-b.

To generate and deploy the unikernels 120a-b that include the software applications 106a-b and the sets of dependencies 126a-b of the software applications 106a-b, the unikernel management system 104 can determine which software applications associated with the computing system 102 satisfy encapsulation criteria 110 of the computing system 102. To do so, in one example, the unikernel management system 104 may determine that the first software application 106a communicates with a software service 130 external to the computing system 102. The software service 130 may be a software service or application that is executing separately from the computing system 102. For example, the software service 130 may execute on one or more physical servers, virtual servers, Internet of Things (IoT) devices, etc. The unikernel management system 104 may determine that the first software application 106a communicates with the software service 130 by analyzing metadata associated with the first software application 106a, API endpoints associated with the first software application 106a, remote calls associated with the first software application 106a, or the like.

Additionally or alternatively, the encapsulation criteria 110 may be based on one or more regulatory standards imposed on the software applications 106a-b. For example, any software applications of the computing system 110 that are associated with a critical-safety system 128 (e.g., a brake system) or otherwise deemed related to a function safety standard may satisfy the encapsulation criteria 110. Moreover, in some examples, the encapsulation criteria 110 can be based on a predetermined set of rules 118. The predetermined set of rules 118 may indicate priority levels of software applications of the computing device 102, security requirements of the software applications of the computing device 102, or the like. Software applications of a certain security level (e.g., software applications that are relatively vulnerable to security threats or software applications for which security is of a relatively high importance) may satisfy the encapsulation criteria 110. In one example, software applications that store or process private data may meet the security requirement of the encapsulation criteria 110. Similarly, software applications to be prioritized on the computing system may also satisfy the encapsulation criteria 110, such as critical systems for operation of the computing system (e.g., a brake system or an advanced driver assistance system of a vehicle).

In some examples, the predetermined set of rules 118 may additionally or alternatively include one or more computing resource thresholds 122 for the software applications. Examples of the computing resource threshold 122 may include a memory threshold, a CPU threshold, or the like. In such examples, the unikernel management system 104 may determine whether a software application satisfies the encapsulation criteria by monitoring usage of a computing resource (e.g., CPU or memory) of the computing system 102 by the software application. For example, the unikernel management system 104 may monitor memory usage of the second software application 106b on the computing system 102. Then, if a level of usage of the computing resource exceeds a corresponding computing resource threshold, the unikernel management system 104 can determine that the encapsulation criteria 110 is satisfied. For example, if a percent of memory usage by the second software application 106b meets or exceeds memory usage threshold, the encapsulation criteria 110 may be satisfied.

In response to determining that the software applications 106a-b satisfy the encapsulation criteria 110, the unikernel management system 104 can identify sets of dependencies 126a-b for executing the software applications 106a-b on the computing system 102. Each set of dependencies can be a minimum set of dependencies for executing the corresponding software application on the computing system 102. Examples of such dependencies include application code, a programming language runtime, a networking stack, operating system components (e.g., memory management, threading or concurrency libraries, interrupt handling, etc.), device drivers, security libraries, protocol libraries, file systems, configuration files, and external communication application programming interfaces), etc.

To identify the sets of dependencies 126a-b the unikernel management system 104 may analyze configuration files, code bases, build scripts, runtime dependencies, or the like for each of the software applications 106a-b. In one particular example, the first software application 106a may be an onboard software application of the computing system 102. In such an example, the unikernel management system 104 can access a code base 115, a configuration file 113, or the like of the first software application 106a to identify a first set of dependencies 126a-b.

Alternatively, in another example, the second software application 106b may be a user downloaded application. In this example, the unikernel management system 104 may analyze a reference database 114, process identifiers 112, network descriptors 116, other data indicative of a second set of dependencies 126b of the second software application 106b, or a combination thereof. For example, the reference database 114 may be a structured repository that includes data (e.g., process tables, connection tracking tables, and configuration files) related to resources, processes, and networks of the computing system 102. Thus, by querying the reference database 114, the unikernel management system 104 can obtain information indicative of the second set of dependencies 126b of the second software application 106b. Additionally or alternatively, the unikernel management system 104 can execute one or more probes (e.g., a strace probe, an eBPF probe, or a dtract probes) to automatically obtain data indicative of the second set of dependencies 126b of the second software application 106b. The probes may monitor runtime behavior of the second software application 106b to capture file accesses, library loads, network connections, or the like of the second software application 106b.

The unikernel management system 104 can then generate the unikernels 120a-b with the software applications 106a-b and the sets of dependencies 126a-b. For example, the unikernel management system 104 can bundle the first software application 106a and the first set of dependencies 126a into a single executable binary to generate a first unikernel 120a. Additionally, the unikernel management system 104 can bundle the second software application 106b and the second set of dependencies 126b into another single executable binary to generate a second unikernel 120b.

The unikernels 120a-b may then be deployed and run directly on a hypervisor or hardware associated with the computing system 102 without interfering with an underlying OS of the computing system 102. Thus, the unikernels 120a-b can provide a resource efficient and isolated means of deploying and executing the software applications 106a-b. Additionally, in contrast to traditional operating systems that may provide a full suite of services and functionality, the unikernels 120a-b can be highly specialized and optimized for specific tasks associated with the software applications 106a-b. As a result, an attack surface and security vulnerabilities of the software applications 106a-b can be minimized, a risk of data breaches or unauthorized access to data communication (e.g., data communication between the first software application 106a and software service 130) can be minimized, and the software applications 106a-b can exhibit deterministic behavior. This, in turn, can facilitate compliance of the software applications 106a-b with regulatory standards.

While FIG. 1 depicts a specific arrangement of components, other examples can include more components, fewer components, different components, or a different arrangement of the components shown in FIG. 1. For instance, in other examples, the computing system 102 can include a different number of software applications or unikernels. Additionally, any component or combination of components depicted in FIG. 1 can be used to implement the process(es) described herein.

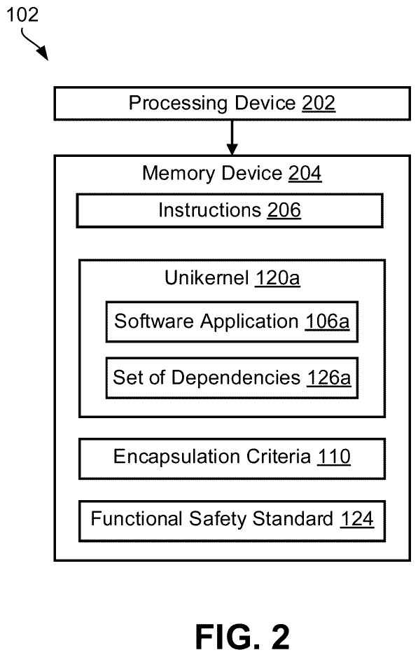

FIG. 2 is a block diagram of an example of the computing system 102 for deploying a software application in a unikernel to facilitate safety compliance according to some embodiments of the present disclosure. The computing system 102 can include a processing device 202 communicatively coupled to a memory device 204.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C #, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code executable to perform operations. Non-limiting examples of a computer-readable medium include magnetic disk(s), memory chip(s), ROM, random-access memory (RAM), an ASIC, a configured processor, and optical storage.

In some examples, the processing device 202 can execute the instructions 206 to perform operations. For example, the processing device 202 can determine that a software application 106a associated with the computing system 102 satisfies encapsulation criteria 110 of the computing system 102. The software application 106a may further be associated with a regulatory standard 124 issued by a standard-setting organization. The processing device 202 may additionally identify a minimum set of dependencies 126a for executing the software application 106a on the computing system 102. The processing device 202 may then generate a unikernel 120a comprising the software application 106a and the minimum set of dependencies 126a. Moreover, the processing device 202 may deploy the unikernel 120a on the computing system 102 to facilitate execution of the software application 106a on the computing device and compliance of the software application 106a with the regulatory standard 124.

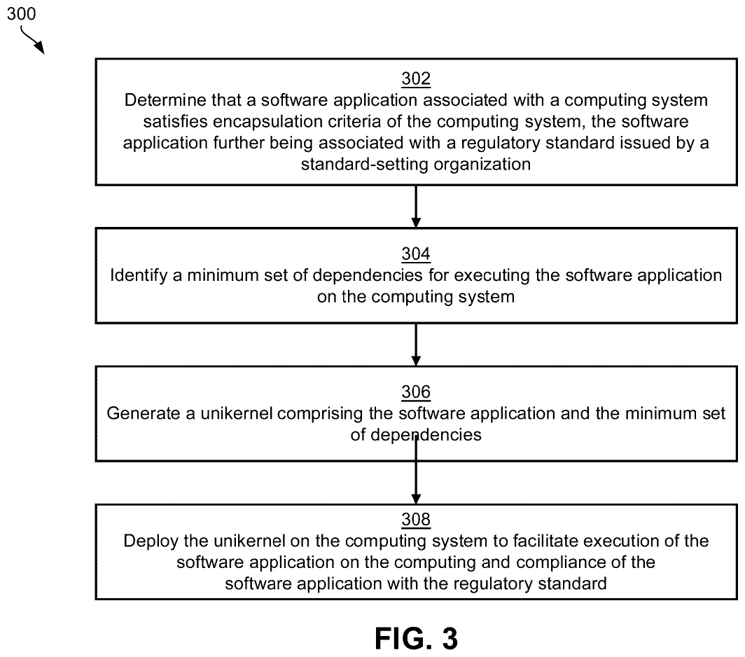

FIG. 3 is a flowchart of a method 300 for deploying a software application in a unikernel to facilitate safety compliance according to some embodiments of the present disclosure. In some examples, the processing device 202 can perform one or more of the steps shown in FIG. 3. For example, the processing device 202 may execute the unikernel management system 104 of FIG. 1 to perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

At block 302, the processing device 202 can determine that a software application 106a associated with a computing system 102 satisfies encapsulation criteria 110 of the computing system 102. The software application 106a may further be associated with a regulatory standard 124 issued by a standard-setting organization (e.g., due to being associated with a critical-safety system 128 of the computing system 102). The encapsulation criteria 110 can be a set of criteria that, when satisfied by a software application, indicate to the processing device 202 that the software application should be encapsulated in a unikernel. The processing device 202 may determine that the software application 106a meets encapsulation criteria 110 based on detecting that the software application 106a communicates with a software service 130 external to the computing system 102.

At block 304, the processing device 202 can identify a minimum set of dependencies 126a for executing the software application 106a on the computing system 102. For example, subsequent to determining that the software application 106a satisfies the encapsulation criteria 110, the processing device 202 can identify a first set of dependencies 126a for executing the software application 106a on the computing system 102. The processing device 202 may do so using probes that can analyze runtime behavior of the software application 106a. The first set of dependencies 126a may include system libraries, runtime libraries, device drivers, operating system components (e.g., a networking stack, memory management, etc.), or other dependencies used to run the software application 106a.

At block 306, the processing device 202 can generate a unikernel 120a comprising the software application 106a and the minimum set of dependencies 126a. The processing device 202 may generate the unikernel 120a by modifying a base unikernel to include the software application 106a and the first set of dependencies 126a. As a result, the unikernel 120a can be a single executable binary that can run the software application 106a.

At block 306, the processing device 202 can deploy the unikernel 120a on the computing system 102 to facilitate execution of the software application 106a on the computing system 102 and compliance of the software application 106a with the regulatory standard 124. The unikernel 120a may be deployed and run directly on a hypervisor or hardware associated with the computing system 102. Thus, the unikernel 120a can provide a resource efficient and isolated means of deploying and executing the software application 106a. Additionally, the unikernel 120a can facilitate compliance with the regulatory standard 124 by being lightweight and therefore having a minimal attack surface. The unikernel 120 can further communicate with the software service 130 via a secure channel to further facilitate compliance with the regulatory standard 124

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
determining that a software application associated with a computing system satisfies encapsulation criteria of the computing system, the software application further being associated with a regulatory standard issued by a standard-setting organization;
identifying a minimum set of dependencies for executing the software application on the computing system;
generating a unikernel comprising the software application and the minimum set of dependencies; and
deploying the unikernel on the computing system to facilitate execution of the software application on the computing system and compliance of the software application with the regulatory standard.

2. The system of claim 1, wherein the operation of determining that the software application associated with the computing system satisfies the encapsulation criteria of the computing system comprises:
determining that software application communicates with a software service external to the computing system.

3. The system of claim 1, wherein the encapsulation criteria is based on a predetermined set of rules, and wherein the predetermined set of rules comprise at least one computing resource threshold.

4. The system of claim 3, wherein the operation of determining that the software application associated with the computing system satisfies the encapsulation criteria of the computing system comprises:
monitoring usage of at least one computing resource of the computing system by the software application; and
determining that a level of usage of the at least one computing resource exceeds the at least one computing resource threshold of the predetermined set of rules.

5. The system of claim 1, wherein the encapsulation criteria is based on the regulatory standard issued by the standard-setting organization.

6. The system of claim 1, wherein the operation of identifying the minimum set of dependencies for executing the software application on the computing system comprises analyzing a reference database, a plurality of process identifiers, and a plurality of network descriptors associated with the software application.

7. The system of claim 1, wherein the operation of identifying the minimum set of dependencies for executing the software application on the computing system comprises analyzing a configuration file associated with the software application.

8. A computer-implemented method comprising:
determining that a software application associated with a computing system satisfies encapsulation criteria of the computing system, the software application further being associated with a regulatory standard issued by a standard-setting organization;
identifying a minimum set of dependencies for executing the software application on the computing system;
generating a unikernel comprising the software application and the minimum set of dependencies; and
deploying the unikernel on the computing system to facilitate execution of the software application on the computing system and compliance of the software application with the regulatory standard.

9. The computer-implemented method of claim 8, wherein determining that the software application associated with the computing system satisfies the encapsulation criteria of the computing system comprises:
determining that software application communicates with a software service external to the computing system.

10. The computer-implemented method of claim 8, wherein the encapsulation criteria is based on a predetermined set of rules, and wherein the predetermined set of rules comprise at least one computing resource threshold.

11. The computer-implemented method of claim 10, wherein determining that the software application associated with the computing system satisfies the encapsulation criteria of the computing system comprises:
monitoring usage of at least one computing resource of the computing system by the software application; and
determining that a level of usage of the at least one computing resource exceeds the at least one computing resource threshold of the predetermined set of rules.

12. The computer-implemented method of claim 8, wherein the encapsulation criteria is based on the regulatory standard issued by the standard-setting organization.

13. The computer-implemented method of claim 8, wherein identifying the minimum set of dependencies for executing the software application on the computing system comprises analyzing a reference database, a plurality of process identifiers, and a plurality of network descriptors associated with the software application.

14. The computer-implemented method of claim 8, wherein identifying the minimum set of dependencies for executing the software application on the computing system comprises analyzing a configuration file associated with the software application.

15. A non-transitory computer-readable medium comprising program code executable by a processing device for causing the processing device to perform operations comprising:
determining that a software application associated with a computing system satisfies encapsulation criteria of the computing system, the software application further being associated with a regulatory standard issued by a standard-setting organization;
identifying a minimum set of dependencies for executing the software application on the computing system;
generating a unikernel comprising the software application and the minimum set of dependencies; and
deploying the unikernel on the computing system to facilitate execution of the software application on the computing system and compliance of the software application with the regulatory standard.

16. The non-transitory computer-readable medium of claim 15, wherein the operation of determining that the software application associated with the computing system satisfies the encapsulation criteria of the computing system comprises:
determining that software application communicates with a software service external to the computing system.

17. The non-transitory computer-readable medium of claim 15, wherein the encapsulation criteria is based on a predetermined set of rules, and wherein the predetermined set of rules comprise at least one computing resource threshold.

18. The non-transitory computer-readable medium of claim 17, wherein the operation of determining that the software application associated with the computing system satisfies the encapsulation criteria of the computing system comprises:
monitoring usage of at least one computing resource of the computing system by the software application; and
determining that a level of usage of the at least one computing resource exceeds the at least one computing resource threshold of the predetermined set of rules.

19. The non-transitory computer-readable medium of claim 15, wherein the encapsulation criteria is based on the regulatory standard issued by the standard-setting organization.

20. The non-transitory computer-readable medium of claim 15, wherein the operation of identifying the minimum set of dependencies for executing the software application on the computing system comprises analyzing a reference database, a plurality of process identifiers, and a plurality of network descriptors associated with the software application.
